(19) United States
(12) Patent Application Publication
(10) Pub. No.: US 2024/0139808 A1
(43) Pub. Date: May 2, 2024

(54) METHOD FOR MANUFACTURING LABYRINTH SEAL FOR TURBINE THROUGH ADDITIVE MANUFACTURING OF MARTENSITIC STAINLESS STEEL USING 3D PRINTING

(71) Applicants: Hyun Ki KANG, Busan (KR); Sam Sub BYUN, Busan (KR); Taek Ho CHUNG, Busan (KR)

(72) Inventors: Hyun Ki KANG, Busan (KR); Sam Sub BYUN, Busan (KR); Taek Ho CHUNG, Busan (KR)

(21) Appl. No.: 18/222,644

(22) Filed: Jul. 17, 2023

(30) Foreign Application Priority Data
Oct. 28, 2022 (KR) 10-2022-0141030

(51) Int. Cl. B22F 5/00; B22F 10/28; B22F 10/50; B33Y 10/00; C22C 38/00; C22C 38/02; C22C 38/04; C22C 38/40

(52) U.S. Cl. CPC B22F 5/009; B22F 10/28; B22F 10/50; B33Y 10/00; C22C 38/002; C22C 38/02; C22C 38/04; C22C 38/40; B22F 2301/35; B22F 2998/10; B22F 2999/00

(57) ABSTRACT

The present invention relates to a method for manufacturing a labyrinth seal for a turbine through the additive manufacturing of martensitic stainless steel using 3D printing, the method including the steps of: making a ring-shaped body of the labyrinth seal by means of centrifugal casting or a ring mill and a labyrinth part protruding from one surface of the ring-shaped body of the labyrinth seal by means of the 3D printing; and depositing a bonding layer onto top of the ring-shaped body to improve a bonding force between the ring-shaped body and the labyrinth part, the bonding layer having a composition similar to the composition of the metal powder or metal wire used in the 3D printing.

### BACKGROUND OF THE INVENTION

### Cross Reference to Related Application of the Invention

The present application claims the benefit of Korean Patent Application No. 10-2022-0141030 filed in the Korean Intellectual Property Office on Oct. 28, 2022, the entire contents of which are incorporated herein by reference.

### Field of the Invention

The present invention relates to a method for manufacturing a labyrinth seal for a turbine, more specifically to a method for manufacturing a labyrinth seal for a turbine through the additive manufacturing of martensitic stainless steel using 3D printing that is capable of making a ring-shaped body of the labyrinth seal by means of centrifugal casting or a ring mill and making a labyrinth part protruding from the ring-shaped body by means of the 3D printing through the additive manufacturing of martensitic stainless steel.

### BACKGROUND OF THE RELATED ART

A turbine is a rotating machine that converts the energy in a stream of fluid into mechanical energy. There are various turbines such as a steam turbine using steam, a gas turbine using combustion gas, and the like, according to their operating principles and structures (See Naver library).

In producing electric power using a turbine for power generation, generally, high temperature high pressure steam produced from a boiler passes through a stop valve and a control valve of the turbine and enters a turbine casing, and next, the steam passes through a diaphragm and rotates moving blades coupled to a turbine rotor, so that a power generator rotates by the turbine rotor and thus produces the electric power.

In this case, the diaphragm serves to induce the introduced steam or gas so that the steam or gas can flow in an optimal direction to thus rotate the moving blades coupled to the turbine rotor.

The leakage of steam, which occurs from a seal between a rotor such as the turbine rotor and a stator such as the diaphragm surrounding the turbine rotor on the outside of the turbine rotor, causes a turbine efficiency to become deteriorated and increases a fuel cost. Accordingly, it is very important to develop such a seal capable of suppressing the leakage of steam.

In this case, stainless steel seals used for high temperature high pressure turbines such as a steam turbine, a gas turbine, and the like serve to prevent steam or gas from leaking to improve the energy production efficiency of a power generator and avoid rotors from being vibrated due to the steam or gas.

To improve performance of the gas turbine, in specific, tries to suppress the flow of gas leaking between the rotor and the stator and thus reduce the loss of gas have been continuously made. A labyrinth seal, which is one of very important parts applied to a secondary flow system of the gas turbine, serves to reduce the leakage flow occurring when a large pressure gradient exists in a clearance generated between a rotator part and a stator part. Even though advanced technologies for reducing the leakage flow have been consistently developed, the labyrinth seal made under a relatively classical technique is still widely used because of its simple structure, heat resistance, and application in a wide pressure range.

The labyrinth seal applied for a seal of a rotary blade tip has a plurality of teeth adapted to increase flow resistance so that sealing performance can be maximized.

As many studies of gas turbine performance improvement are made for several decades, the importance of accurate leakage flow estimation of the labyrinth seal has been emphasized. The sealing performance of the labyrinth seal depends upon the number of tip teeth, tip shape, and tip clearance. The tip clearance and tip shape may be varied by means of the heat expansion and centrifugal force generated when an engine is really driven according to operating conditions of the engine. Before the application of the labyrinth seal, therefore, it is necessary to build data of sealing properties in various tip shape parameters and flow conditions.

However, domestic studies of the labyrinth seal applied to the gas turbine rarely exist, and even in other countries, only studies of limited shapes and pressure rates have been suggested. As a result, a method for manufacturing a labyrinth seal using 3D printing when teeth of the labyrinth seal are made, which is suggested in the present invention, is not found yet.

In the case of the conventional labyrinth seal, a ring-shaped body is made by means of centrifugal casting or a ring mill, and next, teeth are cut using a machining tool, so that an amount of material consumed increases to raise a production cost. Further, it is not easy to make the shapes of the teeth, so that a manufacturing period extends to cause productivity to become deteriorated.

### PRIOR LITERATURE

### Patent Literature

(Patent literature 0001) Korean Patent No. 10-0876603 (Dec. 23, 2008)
(Patent literature 0002) Korean Patent No. 10-1442739 (Sep. 15, 2014)
(Patent literature 0003) Korean Patent No. 10-1449473 (Oct. 2, 2014)
(Patent literature 0004) Korean Patent No. 10-1546385 (Aug. 17, 2015)
(Patent literature 0005) Korean Patent No. 10-1950924 (Feb. 15, 2019)
(Patent literature 0006) Korean Patent No. 10-2293186 (Aug. 18, 2021)

### Non-Patent Literature

(Non-patent Literature 0001) Paper: Basic Research Trends on Labyrinth Seal of Gas Turbine), Lee soo-in, Kyung young-jun, Kim dong-hyung, Kwak jae-soo (Korean Society for Fluid Machinery Journal Vol. 23, No. 1 pp 32-39)

### SUMMARY OF THE INVENTION

Accordingly, the present invention has been made in view of the above-mentioned problems occurring in the related art, and it is an object of the present invention to provide a method for manufacturing a labyrinth seal for a turbine through the additive manufacturing of martensitic stainless steel using 3D printing that is capable of making a ring-shaped body of the labyrinth seal by means of centrifugal casting or a ring mill and making a labyrinth part protruding from the ring-shaped body by means of the 3D printing, so that an amount of material consumed and a machining cost are reduced to improve productivity thereof, and further, an optimal composition of metal powder used upon the 3D printing is provided to expect grain refinement, fusion defect reduction, and bonding force improvement.

To accomplish the above-mentioned object, according to the present invention, there is provided a method for manufacturing a labyrinth seal for a turbine through the additive manufacturing of martensitic stainless steel using 3D printing, the labyrinth seal being mounted between a diaphragm as a stator and a turbine rotor as a rotor to minimize friction between the turbine rotor and the diaphragm during the rotation of the turbine rotor in the diaphragm, induce the gentle rotation of the turbine rotor, and prevent gas leakage, the method comprising the steps of: making a ring-shaped body of the labyrinth seal by means of centrifugal casting or a ring mill and a labyrinth part protruding from one surface of the ring-shaped body of the labyrinth seal by means of the 3D printing; and depositing a bonding layer onto top of the ring-shaped body to improve a bonding force between the ring-shaped body and the labyrinth part, the bonding layer having a composition similar to the composition of the metal powder or metal wire used in the 3D printing.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a sectional view showing a state where seals are mounted onto a turbine;

FIG. 2 is an enlarged sectional view showing a portion of FIG. 1;

FIG. 3 is a sectional view showing a labyrinth seal made through a method for manufacturing the labyrinth seal for a turbine using 3D printing according to an embodiment of the present invention;

FIG. 4 is an enlarged sectional view showing a state where the labyrinth seal made through the method according to the embodiment of the present invention is mounted onto the turbine;

FIG. 5 is a sectional view showing a bonding layer formed between a ring-shaped body and a labyrinth part upon the 3D printing in the method according to the embodiment of the present invention to improve a bonding force between the ring-shaped body and the labyrinth part;

FIG. 6 is a sectional view showing a labyrinth seal made through a method for manufacturing the labyrinth seal for a turbine using 3D printing according to another embodiment of the present invention; and

FIG. 7 is a sectional view showing a bonding layer formed between a ring-shaped body and a labyrinth part upon the 3D printing in the method according to another embodiment of the present invention to improve a bonding force between the ring-shaped body and the labyrinth part.

### DETAILED DESCRIPTION OF THE PREFERRED EMBODIMENTS

The present invention relates to a method for manufacturing a labyrinth seal for a turbine through the additive manufacturing of martensitic stainless steel using 3D printing, the labyrinth seal being mounted between a diaphragm as a stator and a turbine rotor as a rotor to minimize friction between the turbine rotor and the diaphragm during the rotation of the turbine rotor in the diaphragm, induce the gentle rotation of the turbine rotor, and prevent gas leakage, the method including the steps of: making a ring-shaped body of the labyrinth seal by means of centrifugal casting or a ring mill and a labyrinth part protruding from one surface of the ring-shaped body of the labyrinth seal by means of the 3D printing; and depositing a bonding layer onto top of the ring-shaped body to improve a bonding force between the ring-shaped body and the labyrinth part, the bonding layer having a composition similar to the composition of metal powder or metal wire used in the 3D printing.

The 3D printing of the labyrinth part is performed by depositing the metal powder or metal wire through laser cladding.

The metal powder or metal wire used upon the 3D printing is included in STS410 or STS410A.

Further, the metal powder or metal wire used upon the 3D printing comprises carbon (C) in an amount of not more than 0.15% by weight, silicon (Si) in an amount of not more than 1.00% by weight, manganese (Mn) in an amount of not more than 2.00% by weight, phosphorus (P) in an amount of not more than 0.040% by weight, sulfur (S) in an amount of not more than 0.030% by weight, nickel (Ni) in an amount of not more than 16.00% by weight, chromium (Cr) in an amount of from 11.50% by weight to 13.50% by weight, and iron and impurities as the remainder.

Otherwise, the metal powder or metal wire used upon the 3D printing comprises carbon (C) in an amount of not more than 0.15% by weight, silicon (Si) in an amount of not more than 1.00% by weight, manganese (Mn) in an amount of not more than 2.00% by weight, phosphorus (P) in an amount of not more than 0.040% by weight, sulfur (S) in an amount of not more than 0.030% by weight, nickel (Ni) in an amount of not more than 16.00% by weight, chromium (Cr) in an amount of from 13.00% by weight to 15.00% by weight, and iron and impurities as the remainder.

Further, the bonding layer has a thickness in the range of 0.01 to 5 mm.

Further, the bonding layer comprises carbon (C) in an amount of not more than 0.15% by weight, silicon (Si) in an amount of not more than 0.90% by weight, manganese (Mn) in an amount of not more than 2.50% by weight, phosphorus (P) in an amount of not more than 0.040% by weight, sulfur (S) in an amount of not more than 0.030% by weight, nickel (Ni) in an amount of from 6% by weight to 20% by weight, chromium (Cr) in an amount of from 10% by weight to 30% by weight, and iron and impurities as the remainder.

Hereinafter, an explanation of the method for manufacturing a labyrinth seal for a turbine through the additive manufacturing of martensitic stainless steel using 3D printing according to the present invention will be given with reference to the attached drawings.

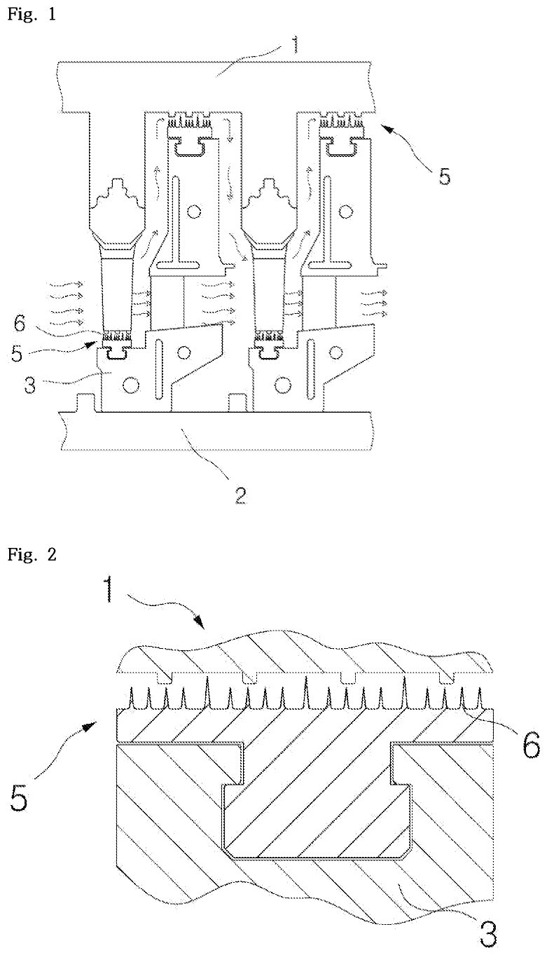

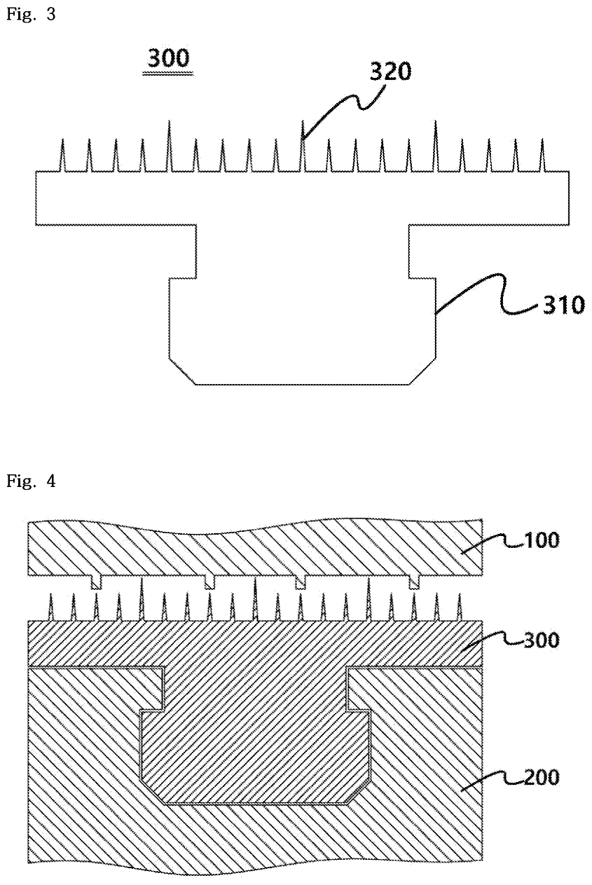

FIG. 1 is a sectional view showing a state where seals are mounted onto a turbine, and FIG. 2 is an enlarged sectional view showing a portion of FIG. 1.

As shown FIGS. 1 and 2, conventional labyrinth seals 5 are disposed on an external ring and an internal ring of a diaphragm 3 mounted on a casing.

In this case, the labyrinth seals 5 are widely used as circular non-contact type seals and have keen teeth 6 adapted to cause a throttling process to a fluid flowing in a turbine to thus reduce the leakage rate of fluid.

In specific, the teeth 6 are arranged sequentially along the flow direction of the fluid to reduce the leakage rate of the fluid through pressure drop generated while the fluid is being repeatedly throttled or expanded.

More detailed explanation of the labyrinth seal is disclosed in Korean Patent No. 10-1442739 (issued on Sep. 15, 2014) as filed by the same applicant on Apr. 8, 2014, which has been mentioned above.

However, the conventional labyrinth seal having the teeth 6 is made by forming a ring-shaped body by means of centrifugal casting and then forming a labyrinth part through a cutting tool, so that an amount of material consumed undesirably increases. Further, it is not easy to make the shape of the labyrinth part, so that a manufacturing period extends to cause productivity of the labyrinth seal to become deteriorated.

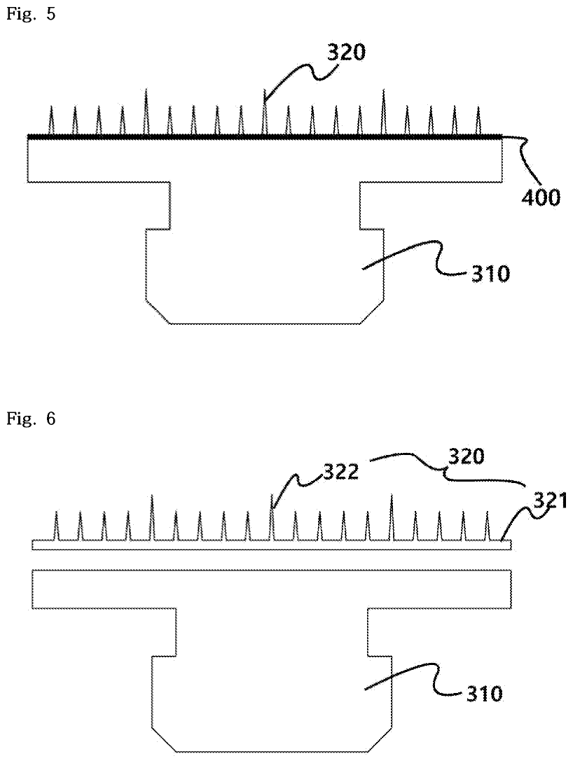

FIG. 3 is a sectional view showing a labyrinth seal made through a method for manufacturing the labyrinth seal for a turbine using 3D printing according to an embodiment of the present invention, FIG. 4 is an enlarged sectional view showing a state where the labyrinth seal made through the method according to the embodiment of the present invention is mounted onto the turbine, and FIG. 5 is a sectional view showing a bonding layer formed between a ring-shaped body and a labyrinth part upon the 3D printing in the method according to the embodiment of the present invention to improve a bonding force between the ring-shaped body and the labyrinth part.

As shown in FIGS. 3 to 5, the present invention relates to a method for manufacturing a labyrinth seal 300 for a turbine using 3D printing, and the labyrinth seal 300 is mounted between a diaphragm 200 as a stator and a turbine rotor 100 as a rotor to minimize friction between the turbine rotor 100 and the diaphragm 200 during the rotation of the turbine rotor 100 in the diaphragm 200, induce the gentle rotation of the turbine rotor 100, and prevent gas leakage.

Generally, the labyrinth seal 300 includes a ring-shaped body 310 and a labyrinth part 320 protruding from one surface of the ring-shaped body 310.

The ring-shaped body 310 of the labyrinth seal 300 is made by means of centrifugal casting or a ring mill, and the labyrinth part 320 of the labyrinth seal 300 is made by means of 3D printing.

In this case, the ring-shaped body 310 and the labyrinth part 320 are not made unitarily with each other but made through different methods. In specific, the labyrinth part 320 is deposited directly onto the ring-shaped body 310 by means of the 3D printing, and otherwise, after the labyrinth part 320 is made by means of the 3D printing, it is bonded to the ring-shaped body 310.

Upon the 3D printing of the labyrinth part 320, firm coupling or bonding of metal powder or metal wire has to be necessarily performed by means of additive manufacturing such as laser cladding.

Martensitic stainless steels are used for an ultra-high temperature part such as a gas turbine because they are not easily oxidized in the air and have given hardenability even though they are lower corrosion resistance than austenitic and ferritic stainless steels.

Stainless steels (STS) are steels that are made by putting chromium (in an amount of 12% by weight) into iron (Fe) so that they can be prevented from getting rusty, and if necessary, they become alloy steels comprising carbon (C), nickel (Ni), silicon (Si), manganese (Mn), molybdenum (Mo), and the like.

In specific, among STS, the composition of the metal powder or metal wire used upon the 3D printing is included in STS410 or STS410S having excellent heat resistance, corrosion resistance, and toughness.

According to the present invention, the STS410-based metal powder or metal wire used upon the 3D printing comprises carbon (C) in an amount of not more than 0.15% by weight, silicon (Si) in an amount of not more than 1.00% by weight, manganese (Mn) in an amount of not more than 2.00% by weight, phosphorus (P) in an amount of not more than 0.040% by weight, sulfur (S) in an amount of not more than 0.030% by weight, nickel (Ni) in an amount of not more than 16.00% by weight, chromium (Cr) in an amount of from 11.50% by weight to 13.50% by weight, and iron and impurities as the remainder.

According to the present invention, otherwise, the STS410S-based metal powder or metal wire used upon the 3D printing comprises carbon (C) in an amount of not more than 0.15% by weight, silicon (Si) in an amount of not more than 1.00% by weight, manganese (Mn) in an amount of not more than 2.00% by weight, phosphorus (P) in an amount of not more than 0.040% by weight, sulfur (S) in an amount of not more than 0.030% by weight, nickel (Ni) in an amount of not more than 16.00% by weight, chromium (Cr) in an amount of from 13.00% by weight to 15.00% by weight, and iron and impurities as the remainder.

Further, as shown in FIG. 5, a bonding layer 400 is formed on top of the ring-shaped body 310 to improve a bonding force between the ring-shaped body 310 and the labyrinth part 320, and after the bonding layer 400 having a composition similar to the composition of the metal powder or metal wire used in the 3D printing has been formed, the metal powder or metal wire is deposited onto the bonding layer 400.

The bonding layer 400 has a thickness in the range of 0.01 to 5 mm.

The bonding layer 400 is deposited by means of laser cladding.

Further, the bonding layer 400 comprises carbon (C) in an amount of not more than 0.15% by weight, silicon (Si) in an amount of not more than 0.90% by weight, manganese (Mn) in an amount of not more than 2.50% by weight, phosphorus (P) in an amount of not more than 0.040% by weight, sulfur (S) in an amount of not more than 0.030% by weight, nickel (Ni) in an amount of from 6% by weight to 20% by weight, chromium (Cr) in an amount of from 10% by weight to 30% by weight, and iron and impurities as the remainder.

According to the present invention, furthermore, while the ring-shaped body 310 and the labyrinth part 320 are being deposited onto top of each other by means of the laser cladding, ultrasonic vibrations are applied to the ring-shaped body 310 or the deposited metal powder.

The ultrasonic vibrations have the range of 2 KHz to 100 MHz.

In specific, a vibrator (not shown) is attached to a position placed at a distance of 0.5 to 2000 mm from a deposited portion to apply vibrations to the ring-shaped body 310 as a base metal, so that optimal ultrasounds are transmitted to the deposited portion, while the additive manufacturing is being performed by means of the laser cladding.

That is, the vibrator comes into contact with the surface of the ring-shaped body 310 at a distance of 0.5 to 2000 mm from a welded position.

As mentioned above, in the case where the additive manufacturing is performed by means of both of the ultrasonic vibrations and the laser cladding, a pore rate of the deposited portion is reduced to 0.01% or under, and further, a grain size is less than 50% of the existing laser cladding, thereby improving mechanical properties (hardness, strength, abrasion, fatigue, and creep).

Further, far infrared rays are applied to the ring-shaped body or the deposited metal powder to achieve more rigid bonding relation between the ring-shaped body 310 and the labyrinth part 320.

In the case of Inconel superalloy having a high melting temperature, a far infrared heater has the wavelength of 10 to 1000 μm to adjust solidification speed of the superalloy so that while the base metal is being kept to a temperature in the range of 25 to 900° C., the laser cladding is performed.

According to the present invention, further, the ring-shaped body 310 is made of a stainless steel, and the labyrinth part 320 is made of a material different from the stainless steel of the ring-shaped body 310.

According to the present invention, the labyrinth part 320 is made through the following method so that the labyrinth part 320 is more conveniently formed using the 3D printing and thus more rigidly bonded to the ring-shaped body 310.

The ring-shaped body 310 is not limited to the shape as shown in FIG. 3, but the body 310 may be made to various shapes corresponding to the shapes of the diaphragm 200 to which the body 310 is fitted.

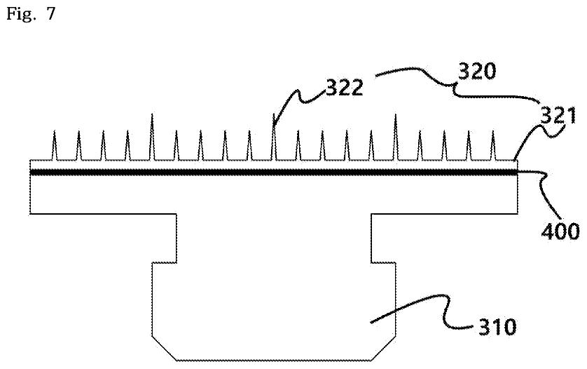

FIG. 6 is a sectional view showing a labyrinth seal made through a method for manufacturing the labyrinth seal for a turbine using 3D printing according to another embodiment of the present invention, and FIG. 7 is a sectional view showing a bonding layer formed between a ring-shaped body and a labyrinth part upon the 3D printing in the method according to another embodiment of the present invention to improve a bonding force between the ring-shaped body and the labyrinth part.

As shown in FIG. 6, the labyrinth part 320 according to another embodiment of the present invention includes a plate-shaped base 321 and teeth 322 protruding from one surface of the base 321.

The teeth 322 have various shapes such as bristles or a plurality of thin plates.

The base 321 of the labyrinth part 320 comes into contact with the ring-shaped body 310 and is thus deposited or bonded onto the ring-shaped body 310 by means of additive manufacturing or bonding such as laser cladding, so that the labyrinth part 320 and the ring-shaped body 310 have firm bonding relation to each other.

In specific, the base 321 of the labyrinth part 320 and the ring-shaped body 310 are made of the same material, so that the labyrinth part 320 and the ring-shaped body 310 have such a firm bonding relation to each other.

The teeth 322 is made of any one selected from materials different from the material of the base 321 according to the material, shape, or performance of the turbine rotor 100.

To achieve more firm bonding relation between the labyrinth part 320 and the body 310, a protruding portion (not shown) is formed on any one of one surface of the base 321 coming into contact with the body 310 and one surface of the body 310 coming into contact with the base 321, and a groove portion (not shown) corresponding to the protruding portion is formed on the other surface, so that the labyrinth part 320 and the body 310 are coupled to each other like blocks coupled to each other and then deposited or bonded by means of the additive manufacturing or bonding such as laser cladding.

Further, as shown in FIG. 7, a bonding layer 400 is formed on top of the body 310 to improve a bonding force between the ring-shaped body 310 and the labyrinth part 320, and after the bonding layer 400 having a composition similar to the composition of the metal powder or metal wire used in the 3D printing has been formed, the metal powder or metal wire is deposited or bonded onto the bonding layer 400 by means of the additive manufacturing or bonding such as laser cladding.

The bonding layer 400 has a thickness in the range of 0.01 to 5 mm, and the composition of the bonding layer 400 is the same as in the above.

According to the present invention, the body 310, the base 321, and the teeth 322 of the labyrinth part 320 may have various shapes within the scope of the present invention.

According to the present invention, in specific, the ring-shaped body 310 of the labyrinth seal 300 is made by means of centrifugal casting or a ring mill, and next, the labyrinth part 320 of the labyrinth seal 300 is deposited onto the surface of the body 310 by means of 3D printing. Otherwise, the labyrinth part 320 is made by means of 3D printing, and next, it is bonded to the body 310.

In this case, the laser cladding is used for the additive manufacturing or bonding.

As mentioned above, the labyrinth seal manufacturing method for the turbine using 3D printing according to the present invention includes the steps of making the ring-shaped body by means of the centrifugal casting or ring mill and making the labyrinth part (or teeth) protruding from the ring-shaped body by means of the 3D printing, so that an amount of material consumed and a machining cost are reduced to improve productivity thereof. According to the present invention, further, the bonding layer having an optimal composition of the metal powder is formed to improve the bonding force between the ring-shaped body and the teeth upon the 3D printing, thereby providing remarkable effectiveness, such as grain refinement, fusion defect reduction, and bonding force improvement.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method for manufacturing a labyrinth seal (300) for a turbine through the additive manufacturing of martensitic stainless steel using 3D printing, the labyrinth seal (300) being mounted between a diaphragm (200) as a stator and a turbine rotor (100) as a rotor to minimize friction between the turbine rotor (100) and the diaphragm (200) during the rotation of the turbine rotor (100) in the diaphragm (200), induce the gentle rotation of the turbine rotor (100), and prevent gas leakage, the method comprising the steps of:
making a ring-shaped body (310) of the labyrinth seal (300) by means of centrifugal casting or a ring mill and a labyrinth part (320) protruding from one surface of the ring-shaped body (310) of the labyrinth seal (300) by means of the 3D printing, the labyrinth part (320) comprising a plate-shaped base (321) and teeth (322) protruding from one surface of the base (321); and
depositing a bonding layer (400) between the ring-shaped body (310) and the labyrinth part (320) to a thickness of 0.01 to 5 mm,
wherein the 3D printing of the labyrinth part (320) is performed by depositing metal powder or metal wire by means of laser cladding, and upon the laser cladding, the ring-shaped body (310) as a base metal is kept to a temperature of 25 to 900° C. using ultrasonic vibrations with the range of 2 KHz to 100 MHz and far infrared rays with the wavelength of 10 to 1000 μm, the metal powder or metal wire used upon the 3D printing comprising carbon (C) in an amount of not more than 0.15% by weight, silicon (Si) in an amount of not more than 1.00% by weight, manganese (Mn) in an amount of not more than 2.00% by weight, phosphorus (P) in an amount of not more than 0.040% by weight, sulfur (S) in an amount of not more than 0.030% by weight, nickel (Ni) in an amount of not more than 16.00% by weight, chromium (Cr) in an amount of from 11.50% by weight to 13.50% by weight, and iron and impurities as the remainder or comprising carbon (C) in an amount of not more than 0.15% by weight, silicon (Si) in an amount of not more than 1.00% by weight, manganese (Mn) in an amount of not more than 2.00% by weight, phosphorus (P) in an amount of not more than 0.040% by weight, sulfur (S) in an amount of not more than 0.030% by weight, nickel (Ni) in an amount of not more than 16.00% by weight, chromium (Cr) in an amount of from 13.00% by weight to 15.00% by weight, and iron and impurities as the remainder, the bonding layer (400) having a composition comprising carbon (C) in an amount of not more than 0.15% by weight, silicon (Si) in an amount of not more than 0.90% by weight, manganese (Mn) in an amount of not more than 2.50% by weight, phosphorus (P) in an amount of not more than 0.040% by weight, sulfur (S) in an amount of not more than 0.030% by weight, nickel (Ni) in an amount of from 6% by weight to 20% by weight, chromium (Cr) in an amount of from 10% by weight to 30% by weight, and iron and impurities as the remainder.
